(19) United States
(12) Patent Application Publication
(10) Pub. No.: US 2014/0197110 A1
(43) Pub. Date: Jul. 17, 2014

(54) PROCESS AND PLANT FOR DECONTAMINATING PHOSPHORIC ACID SOLUTION

(71) Applicant: Gerd Edler, Volkach (DE)

(72) Inventor: Gerd Edler, Volkach (DE)

(73) Assignee: BABCOCK NOELL GMBH, Wuerzburg (DE)

(21) Appl. No.: 14/128,026

(22) PCT Filed: Jun. 23, 2011
(86) PCT No.: PCT/EP2011/003102

§ 371 Date: Dec. 20, 2013

(51) Int. Cl. C02F 1/52; C02F 11/18

(52) U.S. Cl. CPC C02F 1/5272; C02F 11/18
USPC 210/710; 210/729; 210/178

(57) ABSTRACT

The invention relates to a method for recycling of phosphoric acid solution from a decontamination bath, which solution is contaminated with radioactive components, wherein the used phosphoric acid solution is diluted with aqueous oxalic acid solution, in order to separate off iron oxalate in this connection, and the phosphoric acid solution is used for decontamination of further system parts, wherein the iron ion content in the phosphoric acid in the decontamination bath is continuously measured, and phosphoric acid is continuously withdrawn from the decontamination bath and concentrated and purified phosphoric acid is replaced, so that a specific concentration of dissolved iron in the contamination bath is not exceeded, and to a system for implementation of the method. The solution has the advantage that only small amounts of phosphoric acid are in circulation in a system for recycling of a phosphoric acid solution from a decontamination bath, whereby the required work volume in the system tanks is significantly reduced. Resulting from this, it is possible to undertake purging of iron ions stemming from electrochemical decontamination, from phosphoric acid solution, using mobile systems.

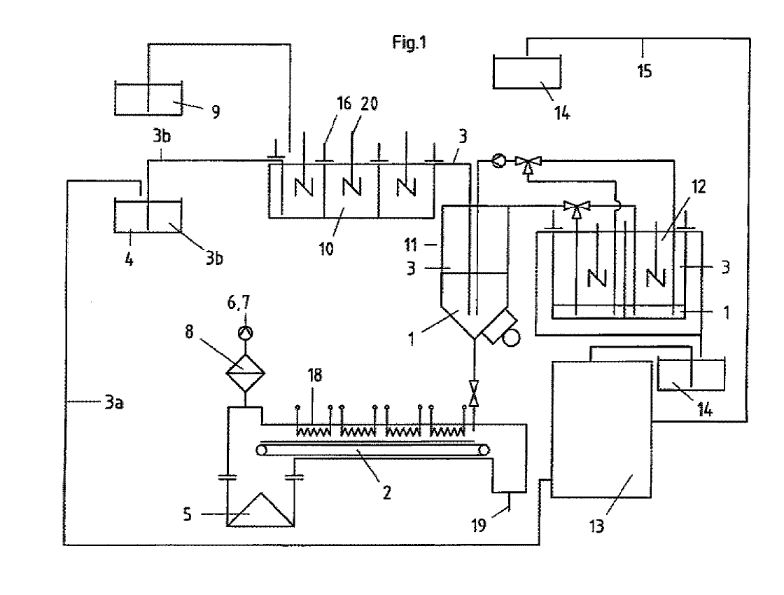

The invention relates to a method according to the characteristics of the first claim and to a system according to the characteristics of claim 7.

The invention can be used anywhere where iron(II) ions are present in a phosphoric acid solution in the chemical and/or electrochemical decontamination of the surface of radioactively contaminated system parts, and the iron(II) ions must be removed from the phosphoric acid solution, so, that it can be used again for the decontamination of radioactively contaminated system parts.

The invention is particularly suitable for use in small and mobile systems, in which the phosphoric acid is continuously purified and returned to the bath.

Phosphoric acid electrolyte baths have been in use for electrochemical decontamination for a long time. After extended use, the iron content and the activity in the electrolyte solution increase. At a specific iron concentration in the phosphoric acid electrolyte bath, of 100 g Fe/per liter, for example, use of the electrolyte becomes inefficient because the decontamination effect does not occur and the time expenditure becomes extremely great. For this reason, the electrolytes are discarded and disposed of. Another possibility consists in treating the aqueous phosphoric acid solution of the decontamination bath and returning it to the decontamination bath.

The decontamination effect consists in that the surface of a steel component is cleared/dissolved to a depth of approximately 0.03 mm by means of phosphoric acid. The dissolved steel or iron is not radioactive; only the dirt that adheres to the surface is radioactive. This dirt is precipitated along with the iron, but makes up only a minimal proportion of the volume.

A possibility for treatment of aqueous phosphoric acid solution is described in EP 026125527. In this method, phosphoric acid solution is mixed with aqueous oxalic acid, in batches, whereby iron oxalate is precipitated and can be removed. The diluted phosphoric acid is concentrated again and returned to the decontamination process (recycled). The iron oxalate that is formed is conditioned using thermolysis.

Thermolysis is a chemical reaction in which a starting substance is decomposed to form multiple products. In contrast to thermal decomposition (pyrolysis), thermolysis is used in targeted manner to produce defined products or reactive intermediate stages.

Because the method is carried out discontinuously, correspondingly large containers must be available for purification of the phosphoric acid solution, and this requires a correspondingly large system and makes the method more expensive. In this way, a relatively large amount of radioactive material is circulating, and this brings with it a greater potential of endangerment. Mobile systems of this type, with smaller amounts of phosphoric acid, are not very cost-effective and can hardly be implemented.

It is therefore the task of the invention to develop a method and a system for recycling of a phosphoric acid solution from a decontamination bath, with little endangerment potential, in which smaller amounts of phosphoric acid solution are in circulation.

This task is accomplished with a method according to the characteristics of the first claim and a system according to the characteristics of claim 7.

Dependent claims reproduce advantageous embodiments of the invention.

The solution according to the invention provides for a method for recycling of phosphoric acid solution from a decontamination bath, which solution is contaminated with a radioactive component, wherein the used phosphoric acid is diluted with aqueous oxalic acid solution, in order to separate off iron oxalate, and to use the phosphoric acid solution for decontamination of further system parts.

According to the invention, the iron ion content in the phosphoric acid in the decontamination bath is continuously withdrawn and measured. Continuous withdrawal can be undertaken by a person or by a withdrawal device. The iron(II) ions are relevant for setting the process parameters, because the iron(III) ions that might also be present in the fluid are not precipitated and pass through the process unchanged. Continuous measurement can take place online, once a minute, once an hour, or once a day.

According to the invention, phosphoric acid is continuously withdrawn from the decontamination bath and replaced with concentrated, purified phosphoric acid, so that a specific concentration of dissolved iron is not exceeded.

This iron concentration in the decontamination bath should lie at 40 to 120 g Fe/liter, preferably at 75 to 95 g Fe/liter.

It is advantageous to add oxalic acid solution to the phosphoric acid contaminated with dissolved iron. This can be done stoichiometrically or sub-stoichiometrically. Sub-stoichiometric addition is advantageous. It is true that an optimal degree of effectiveness is not achieved with this, but the oxalic acid is prevented from putting an unnecessary burden on the process as a whole. Addition can be performed continuously, by a person or by an addition device.

Furthermore, it is advantageous to carry out mixing of oxalic acid and phosphoric acid contaminated with dissolved iron ions in a multi-stage mixing process. A two-stage to four-stage mixing process is suitable. This mixing process can take place by means of measures known to a process technician. For this purpose, stirrers, mixers or assemblies suitable for a mixing process are known to a process technician.

Furthermore, it is advantageous if iron oxalate sludge separated from the diluted phosphoric acid is continuously separated into iron oxide, CO₂, and CO, using a heater.

In a further embodiment variant, it is advantageous to have the heater be followed by a catalyst for the oxidation of CO to CO₂.

The system according to the invention for recycling of phosphoric acid contaminated with iron ions consists of a decontamination bath containing the contaminated phosphoric acid, the container containing oxalic acid, and the settling basin.

The system is characterized by a continuously operated mixer in which oxalic acid and phosphoric acid contaminated with iron oxide are mixed.

Furthermore, a discharge device is disposed behind the mixing chambers of the mixer, for example in the overflow from the mixer to the settling basin, whereby iron oxalate sludge and diluted phosphoric acid are continuously withdrawn from the settling basin.

It is advantageous to provide a post-clarification tank having an overflow to the evaporator, whereby a line for concentrated phosphoric acid leads from the evaporator to the decontamination bath.

The system according to the invention furthermore has a conveyor-belt oven in which iron oxalate is continuously broken down into iron oxide, CO₂, and CO.

It is advantageous if the system has a measurement device for continuous measurement of the iron ion content in or on the contamination bath.

Furthermore, it is advantageous if the system has an apparatus for continuous addition of concentrated phosphoric acid into the decontamination bath. This can be done, for example, by means of a metering device, for example a regulatable pump.

Furthermore, it is advantageous if the system has an apparatus for continuous addition of oxalic acid into the mixer.

The addition of concentrated phosphoric acid and/or oxalic acid can take place by means of gravity if the buffer tank is disposed high enough. If this is not the case, it is advantageous to provide one or more pumps.

In order to be able to conduct the mixing process in multiple stages, it is advantageous to dispose multiple mixers having mixing chambers and discharge devices between two to four mixers, for example.

Overflows, pumps or valves can be used as discharge devices in the system.

The solution according to the invention has the advantage that only small amounts of phosphoric acid solution are in circulation in a system for recycling of a phosphoric acid solution from a decontamination bath, whereby the required work volume in the system tanks is significantly reduced. Resulting from this, it is possible to undertake purging of iron(II) ions stemming from electrochemical decontamination, from phosphoric acid solution, using mobile systems.

In the following, the invention will be explained in greater detail using an exemplary embodiment and a FIGURE of the system.

The FIGURE shows a system for decontamination of phosphoric acid solution 3b, consisting of a decontamination bath 4 in which phosphoric acid containing dissolved iron(II) and iron(III) is situated. This is passed to a multi-stage mixer 10, in which stirrers 20 are disposed, by means of the line and a pump. Oxalic acid 9 is pumped into the multi-stage mixer 10 from a further container. Overflows 16 are disposed between the container the multi-stage mixer 10. Diluted phosphoric acid 3 is pumped off out of the mixer 10, and gets into the sedimentation tank 11 in which diluted phosphoric acid 3 and iron oxalate sludge 1 are formed as the result of a settling process. A vibration mechanism 17 is situated at the lower part of the sedimentation tank 11. This mechanism ensures that the sedimentation sludge does not solidify and can be discharged downward without problems. The heater, which represents a conveyor-belt oven 2, is disposed underneath the sedimentation tank 11, whereby in the present case, multiple heating elements 18 dry the damp iron oxalate sludge by way of a belt, and decompose it thermally, so that the sludge can be ejected as iron oxide 5 and processed further. For acceleration of the drying process and for oxidation, incoming air 19 is passed over the belt, whereby a filter 8 is disposed above the belt, in which filter dust is filtered out.

The diluted phosphoric acid 3 of the sedimentation tank 11 is pumped into a post-clarification tank 12 in the present example, in which tank residual amounts of iron oxalate sludge 1 settle. Diluted phosphoric acid 3 is passed into the buffer tank 14 from this post-clarification tank 12; an evaporator 13 follows the buffer tank, and concentrated phosphoric acid 3a leaves the evaporator and is passed back into the decontamination bath 4.

### LIST OF REFERENCE SYMBOLS USED

1 iron oxalate sludge
2 heater/conveyor-belt oven
3 phosphoric acid, diluted
3a phosphoric acid, concentrated
3b phosphoric acid with iron(II) and iron(III) dissolved in it
4 decontamination bath
5 iron oxide/iron phosphate
6 CO₂
7 CO
8 filter/catalyst
9 oxalic acid
10 multi-stage mixer
11 sedimentation tank/settling basin
12 post-clarification tank
13 evaporator
14 buffer tank
15 water
16 overflow
17 vibration mechanism
18 heating system
19 incoming air
20 stirrer

1. Method for recycling of phosphoric acid solution from a decontamination bath (4), which solution is contaminated with radioactive components, wherein the used phosphoric acid solution is diluted with aqueous oxalic acid solution, in order to separate off iron oxalate in this connection, and the phosphoric acid solution is used for decontamination of further system parts, wherein
the iron ion content in the phosphoric acid (3b) in the decontamination bath (4) is continuously measured,
phosphoric acid (3b) is continuously withdrawn from the decontamination bath (4) and concentrated and purified phosphoric acid (3a) is replaced, so that a specific concentration of dissolved iron in the contamination bath (4) is not exceeded.

2. Method according to claim 1, wherein the iron ion content in the phosphoric acid (3b) lies between 40 to 120 g Fe/liter phosphoric acid (3b).

3. Method according to claim 2, wherein the iron ion content in the phosphoric acid (3b) lies between 75 to 95 g Fe/liter phosphoric acid (3b).

4. Method according to claim 1, wherein the oxalic acid solution (9) is added to the phosphoric acid (3b) contaminated with dissolved iron to the extent that the latter contains dissolved iron.

5. Method according to claim 1, wherein mixing of oxalic acid (9) and of phosphoric acid (3b) contaminated with dissolved iron oxide takes place in a multi-stage mixing process.

6. Method according to claim 1, wherein the iron oxalate sludge (1) separated off from a diluted phosphoric acid (3) is continuously separated into iron oxide (5), CO₂ (6), and CO (7) in a heater.

7. System for implantation of a method according to claim 1, consisting of a decontamination bath (4) containing the contaminated phosphoric acid (3b), the container containing oxalic acid (9), and the settling basin (11), comprising
a continuously operated mixer (10), in which oxalic acid (9) and phosphoric acid (3b) contaminated with iron oxide are mixed,
a discharge device between the mixing chambers of the mixer (10),
a discharge device from the mixer (10) to the settling basin (11), from which iron oxalate sludge (1) and diluted phosphoric acid (3) are continuously withdrawn, and
a conveyor-belt oven (2), in which iron oxalate (1) is continuously broken down into iron oxide, CO₂ (6), and CO (7).

8. System according to claim 7, comprising a post-clarification tank (12) having an overflow (19), a pump or valve, to the evaporator (13), from which a line for concentrated phosphoric acid (3a) leads to the decontamination bath (4).

9. System according to claim 8, comprising a two-stage to four-stage mixer (10).

10. System according to the claim 6, comprising an apparatus for continuous addition of concentrated phosphoric acid (3a) into the decontamination bath (4).

11. System according to claim 6, comprising an apparatus for continuous addition of oxalic acid (9) into the mixer (10).

12. System according to claim 7, wherein the discharge devices or the addition devices represent a pump, a valve or an overflow.
